(19) United States
(12) Patent Application Publication
(10) Pub. No.: US 2014/0367365 A1
(43) Pub. Date: Dec. 18, 2014

(54) Method to make fillet welds

(71) Applicants: YuMing Zhang, Nicholasville, KY (US); Yi Lu, Lexington, KY (US); Jinsong Chen, Lexington, KY (US); Zeng Shao, Lexington, KY (US)

(72) Inventors: YuMing Zhang, Nicholasville, KY (US); Yi Lu, Lexington, KY (US); Jinsong Chen, Lexington, KY (US); Zeng Shao, Lexington, KY (US)

(73) Assignee: Adaptive Intelligent Systems LLC

(21) Appl. No.: 13/986,864

(22) Filed: Jun. 13, 2013

(51) Int. Cl. B23K 9/18

(52) U.S. Cl. CPC B23K 9/188
USPC 219/73

(57) ABSTRACT

For fillet welding, sufficient amounts of metal must be deposited in order to make welds with sufficient sizes. In conventional submerged arc welding (SAW), the heat input is proportional to the amount of metal melted and is thus determined by the required weld size. In order to reduce the needed heat input, Double-Electrode SAW (DE-SAW) method is used for fillet joints. To minimize the heat input required to produce the welds with required geometry and sizes, a gap is introduced between the panel and the tee forming a modified fillet joint design. The use of the gap improves the ability of DE-SAW to produce the required weld beads at reduced heat input and penetration capability. Major parameters including the gap, travel speed and heat input level have been selected/optimized/minimized to produce required fillet weld beads with a minimized heat input based on qualitative and quantitative analyses.

### BACKGROUND

Submerged arc welding (SAW) is a widely used arc welding process. Similar to conventional gas metal arc welding (GMAW) [1, 2] and flux-cored arc welding (FCAW) [3, 4], it melts a continuously fed consumable solid or flux cored electrode wire [5-7] to deposit metal into the work-piece. In the SAW process, however, the consumable wire and the arc are better shielded from atmospheric contamination because of being submerged under a blanket of granular, fusible flux [8]. SAW has significant advantages [6-9] over GMAW and FCAW including higher productivity, more stable arc, spatter-free, and harmful ultraviolet radiation free. Moreover, the molten metal is effectively protected by a layer of fused flux, which together with the un-fused flux can be recovered again before the cooling process [10]. SAW is thus the most commonly used process for down-hand mechanical welding in the shipbuilding industry, especially in joining plates for ship shells, decks, and bulkheads [10]. In a typical 150,000 DWT (Deadweight Tonnage) tanker, the length of the horizontal fillet welding (a kind of down-hand welding) can reach more than 70% of the whole welding length of the bottom shell block at the assembly stage [11].

Due to the requirement to the weld size in fillet welding, a sufficient amount of metal must be melted. In conventional SAW, the heat input is proportional to the amount of metal melted and deposited in the process. As a result, the large heat input causes unwanted distortions on the welded structures whose follow-up straightening is highly costly. In order to reduce the excessive heat input in fillet welding, the Double-Electrode SAW (DE-SAW) process can be practiced in which the total welding current divides into the base metal current and bypass current after it melts the main wire. Since part of the current is bypassed without flowing into the work-piece, the heat input into the work-piece is reduced. When the metal from the bypass wire melted by the bypass arc is added into the work-piece, the reduced heat input is added back but the metal deposition is increased. The DE-SAW process is therefore capable of depositing the same amount of metal at reduced heat input or depositing more metal at the same heat input similarly as its original variant, i.e., the double-electrode gas metal arc welding (DE-GMAW) [12-19].

Thin plates are easy to distort after welding. An effective method to reduce the post-weld distortion is to reduce the heat input. While DE-SAW process is capable of deposit the same metal with reduced heat input, a reduction in the heat input also reduces the penetration capability needed to produce the required weld geometry. Using the DE-SAW process to make required fillet welds with minimal heat input requires a system of methods. This invention provides a system of methods to make required welds on fillet joints formed using relatively thin plates. The parameters are given for 3/16″ thick plates as example but can be easily extended into different thickness.

### BRIEF DESCRIPTION OF THE DRAWINGS

FIG. 1 (This Invention) illustrates the modified joint design, for fillet welding using DE-SAW, where a gap is intentionally introduced between the panel and tee.

FIG. 2 (This Invention) shows the diagrammatic sketch of the DE-SAW system used to make fillet welds on the modified joints.

FIG. 3 (This Invention) illustrates the relationship among different currents in the DE-SAW process used to make fillet welds on the modified joints.

FIG. 4 (This Invention) illustrate the variables used to describe the geometrical relationship of the wires in the DE-SAW with the fillet joint.

FIG. 5 (This Invention) illustrates the alignment tool, i.e., an angular beam used to help align and place the wires and torches in the DE-SAW appropriately to the fillet joint.

FIG. 6 (This Invention) illustrates the steps during the alignment process which aligns the wires and torches to the fillet joint in order to use the DE-SAW to make the fillet welds.

### DETAILED EXPLANATION OF THE INVENTION

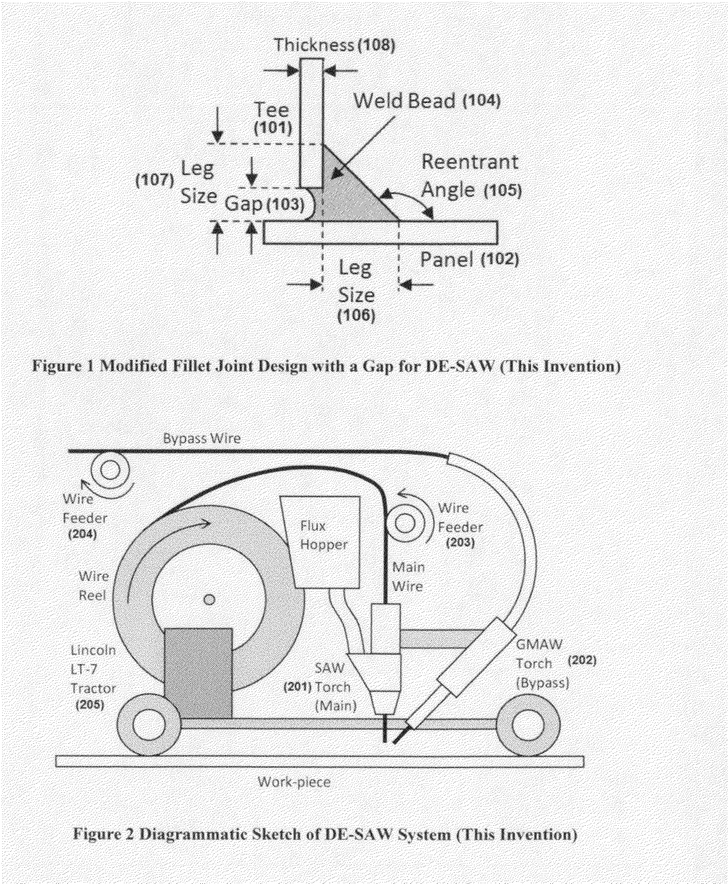

The goal of this invention is to provide an innovative method to make fillet welds with minimal heat input while meeting the requirements. The requirements of the welds include (1) geometrical shape of the welds; (2) the sizes of the welds. In particular, the geometrical shape is represented by the re-entrant angle 105 as shown in FIG. 1. This angle is typically required to be at least 90°. The sizes of the welds are measured by the horizontal and vertical leg sizes (106 and 107) as illustrated in FIG. 1. The minimum of the two leg sizes is typically required be no less than the thickness 108 of the plates (assuming the thicknesses of the panel and tee are the same). This invention consists of the following constituents.

### System

The invention requires the use of a welding system shown in FIG. 2, i.e., a DE-SAW system. This system is established based on a conventional SAW system by adding a GMAW torch 202 next to the SAW torch 201 to provide a second/bypass loop for the welding current. The main wire feeder 203 is combined with and carried/moved by a tractor 205 or any other motion system. The bypass wire needs to be fed from another wire feeder 204.

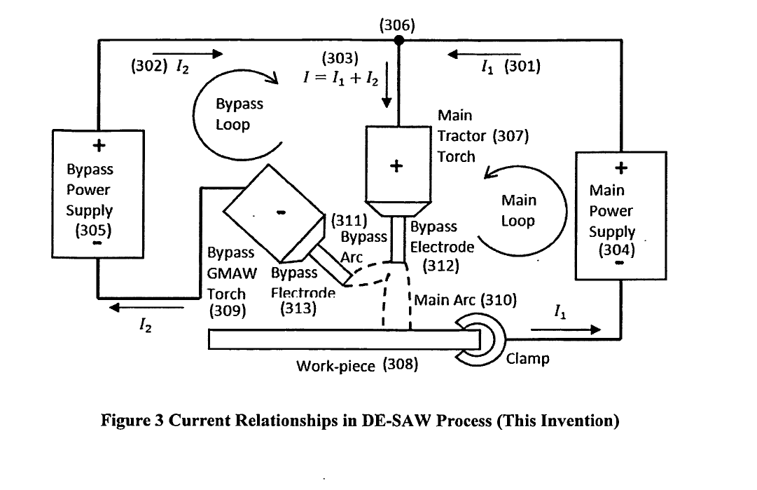

The relationship of the welding currents in the DE-SAW process can be explained by FIG. 3. The main loop represents the path through which the base metal current (I₁) 301 flows, and the bypass loop is the path through which the bypass current (I₂) 302 flows. The positive terminals of the two power supplies (304 and 305) (both of them are working in CV or constant-voltage mode) are connected together as a common positive terminal 306. The main SAW torch 307 is connected to the common positive terminal 306; the work-piece 308 (or base metal) is connected with the negative terminal of the main power supply. This kind of connection is based on the direct current positive polarity (DCEP) mode. For most of the applications, DCEP mode is used because of its benefits to the arc stability, metal transfer and deep penetration [20]. The bypass GMAW torch 309 is connected to the negative terminal of the bypass power supply. After the power supplies are turned on, the main arc 310 is established between the tip of the electrode of the main torch and the surface of the work-piece, and the bypass arc 311 is established between the tip of the main electrode and the tip of the bypass electrode.

As shown by the arrows in FIG. 3, the base metal current (I₁) 301 flows from the main electrode 312 to the work-piece 308; the bypass current (I₂) 302 flows from the main electrode 312 to the bypass electrode 313. Because both the base metal current and the bypass current flow through the main wire electrode, the current inside the electrode of the main SAW torch equals the total welding current (I). This fundamental relationship can be expressed by Equation (1):

I=I₁+I₂ (1)

where,
I is the total welding current;
I₁ is the base metal current that flows through the work-piece;
I₂ is the bypass current that flows through the bypass wire.

The heat input into the work-piece 308 is proportional to the total current 303. If the bypass current I₂ 302 is zero, this is a conventional SAW process whose wire deposition and heat input are both proportional to the total current. For DE-SAW where the bypass current I₂ 302 is not zero, the total heat input and the deposition rate of the main wire will be the same as those in the conventional SAW; however, additional deposition wire is added due to the bypass current I₂ 302. Greater amount of the wire deposition is thus provided by the DE-SAW despite the same heat input. The increase in the wire deposition is determined by the bypass current I₂ 302. Because the bypass wire is melted by the cathode whose voltage is approximately twice of that of the anode, the increase of the wire deposition contributed by the bypass current can be significant.

### Alignment

The DE-SAW is a relatively complex process in comparison with the conventional single-wire SAW. To use this process to successfully make fillet welds, the position and angle of the bypass torch in relation to the main torch, as well as the position and angle of the main torch in relation to the filet joint, need to be appropriate. In addition, convenient methods are needed to assure these desired positions and angles.

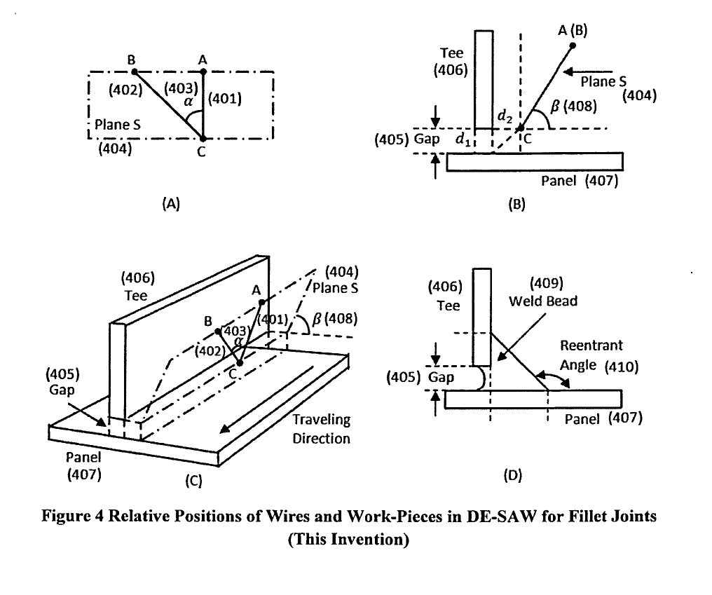

The alignment can be explained by FIG. 4 in two-dimension and three-dimension.

In Part (A) of FIG. 4, the line segment A̅C̅ represents the extension (stick-out) of the main wire electrode 401; the line segment B̅C̅ stands for the extension of the bypass wire electrode 402. The main wire and the bypass wire (or their extensions) intersect at point C. The angle ∠α represents the angle between by the two wires. For convenience, this angle ∠α is referred to as the inter-wire angle 403. Generally, ∠α is around 45° approximately. The plane in which the two wires are located is called plane S 404.

Part (B) of FIG. 4 displays the cross-section of the fillet welding of DE-SAW. Because viewed with a 90° difference, plane S shown in Part (A) becomes into a line segment 404 in Part (B), and point A and B overlap into one point. From this view, a gap 405, d₁, between the tee 406 and the panel 407 plate can be seen and this gap 405 will be further discussed later. The point of intersection (Point C) of the two wires is equidistant from the tee and the panel. It is found that they should be both 1.5 mm approximately for 3/16 inch thick plates. The angle ∠β represents the angle between plane S and the surface of the panel. For convenience, this angle ∠β is referred to as the torch angle 408. Because of the gravity, the melted metal will flow downwards. In order to make sure both of the leg sizes of the weld bead are equal, the angle ∠β 408 should be greater than 45°. It is found that ∠β 408 should be 60° approximately.

In Part (C) of FIG. 4, the process of DE-SAW for fillet joints is shown in three-dimension. Along the traveling direction pointed by the arrow, both of the main wire 401 and the bypass wire 402 are moving together in the plane S 404. The bypass wire 402 fixed to the main torch is ahead of the main wire 401 along the traveling direction. During the entire welding process, the main wire 401 (line segment A̅C̅) is vertical to the traveling direction; the relative position of main wire and bypass wire does not change; and the point of intersection (Point C) of the two wires is equidistant from the tee and the panel.

By following the standards and rules demonstrated by Part (A), (B) and (C) in FIG. 4, the expected shape of the weld bead 409 is shown in Part (D) of FIG. 4. The two leg sizes, the re-entrant angle 410 and the flatness of the weld bead are the main concern for the quality. In reality, the ratio of the gap size to the leg size should be much smaller than the illustration sketch.

Although the alignment issue can be explained clearly by FIG. 4, its convenient compliance remains an issue. After all, the condition described in FIG. 4 is merely a kind of extremely ideal case. Once the line in which the tee is located is not parallel with the traveling direction of the tractor, then uneven weld beads may appear because the distance between the tips of the two electrodes and the distances between the electrodes to the work-pieces (d₁ and d₂ in Part (B) of FIG. 4) will keep changing from time to time.

### Alignment Tool and Method

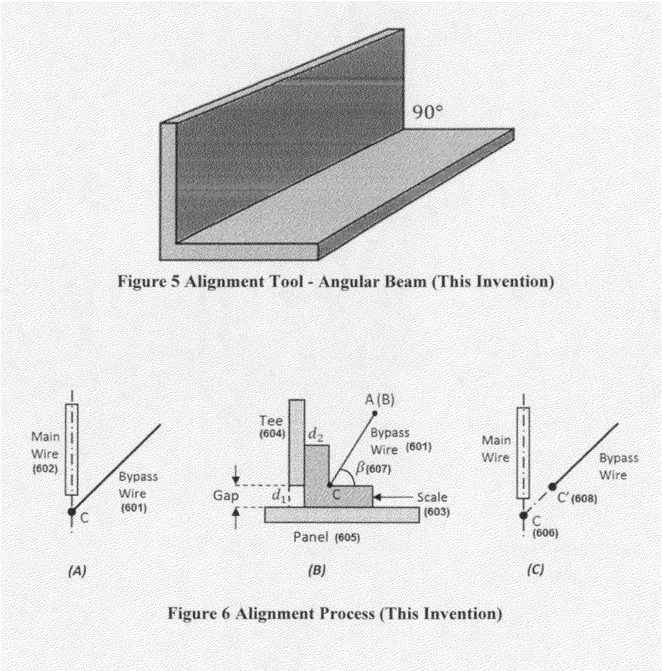

In order to simplify the alignment process and guarantee the alignment standards, a special tool, the alignment scale shown in FIG. 5, can be made from an aluminum-alloy angle. The thickness of this angular beam is just equal to the desired width of the gap between the tee and the panel (1.5 mm approximately).

The alignment process with the help of the alignment scale can be illustrated by the three steps in FIG. 6.

Step 1: extending the bypass wire until the tip of the bypass wire 601 to the extension line of the main wire 602 as shown by the Part (A). Due to the diameter of the main wire is relatively large ( 3/32 inch), only the tip of the bypass wire can be located at the point of intersection (Point C).

Step 2: placing the alignment scale 603 on the work-piece. The two outer surfaces of the scale should in close contact with the tee 604 and panel 605 as shown by the Part (B) in FIG. 6. Then, lower the (set of) torches so that the tip 606 of the bypass wire 601 is close enough to the corner of the angular beam, i.e. point C 606. The angle ∠β 607 can be guaranteed by the scale marked on the turning axis of the tractor. This alignment process should be done at both the beginning spot and the ending spot of the whole welding process, so that the line in which the tee is located is in parallel with the traveling direction of the tractor.

Step 3: retreating the bypass wire backwards from C 606 so that the distance between C and C′ 608 in Part (C) of FIG. 6 is at least 0.5 mm. At last, move the torches to the starting spot and get ready for the welding.

By following these three steps for the alignment shown in FIG. 6, the standards/rules about wire alignment should be assured. The performance of the fillet welding after using this invented alignment tool and method has been proved by extensive repeatability experiments.

### Start of High Speed DE-SAW Fillet Welding

DE-SAW process promises a higher travel speed because of the increased wire deposition speed. However, for the DE-SAW process, the bypass arc established between the main wire and bypass wire is less stable. The beginning segment of the weld will be made when the arc transients from the single arc to two arcs and from main wire deposition and two wire deposition. The welds made using the same parameters in the beginning segment may not be the same after the arcs and wire feed speeds become stationary.

Various methods have been tried to make welds in the beginning segment to be acceptable without success for welding fillet joints formed by 3/16 inch thick plates at 45 inch/min travel speed. It is found that a convenient and acceptable way is to gradually increase the travel speed in a few seconds once started, for example, first 3 seconds. The travel speed mat be manually adjusted or pre-programmed depending on the motion system used.

### Use of Gap

The DE-SAW can reduce the heat input while still supplying the same amount of metal. However, after having the heat input reduced greatly in the fillet joints by using the DE-SAW process, the penetration capability is also reduced due to the reduction in the base metal current. The weld beads produced become convex causing the reentrant angle reduced undesirably. Decreasing the penetration capability required for producing desirable welds is thus an issue that needs to be resolved in order to effectively utilize the ability of DE-SAW in reducing the heat input to produce desirable fillet weld beads.

In this invention, an intentional gap 405 (d₁>0) is used to reduce the penetration capability needed to make the weld approximately flat rather than being convex. For fillet joints formed with 3/16 inch thick plates, it is found that d₁ 405 should be ⅛ inch approximately to minimize the heat input to produce required welds.

### Welding Procedure for Fillet Joint Formed by 3/16 Inch Thick Plates

The welding procedure/parameters to weld fillet joints formed with 3/16 inch thick plates using the invented method with the bypass system shown in FIG. 1 are summarized in Table 1. The parameters specified in the table can produce quality welds with minimal heat inputs but each of these parameters can certainly be changed in a certain range without affecting the results significantly.

TABLE 1
Welding Procedure for Fillet Joints with 3/16 Inch Thick Plates

| | |
|---|---|
| Main Wire | Diameter: 3/32 inch |
| Bypass Wire | Diameter: 0.045 inch |
| Main Wire Feed Speed/Total Current | 90 IPM approximately/400 A |
| Bypass Wire Feed Speed/Bypass Current | 294 IPM approximately/160 A |
| Main Arc Voltage | 28 V approximately |
| Bypass Arc Voltage | 28 V approximately |
| Travel Speed | 45 IPM approximately |
| Travel Transition Time | 2 seconds approximately |
| Gap | 1.5 mm approximately |
| Inter-wire Angle α | Approximately 45 degree |
| Torch Angle β | Approximately 60 degree |
| Thickness of Alignment Angular Beam | Approximately 1.5 mm |
| Bypass Wire Setback | 0.5 mm or greater |

What is claimed is:

1. An arc welding method that uses adjustments on the main wire and bypass wire feed speeds in a double-electrode submerged arc welding system to control the base metal current and wire deposition speed at the needed levels. The double-electrode submerged arc welding system includes a main torch, a bypass torch, a main wire, a bypass wire, a main wire feeder whose speed is adjustable, a bypass wire feeder whose speed is adjustable, a main power supply whose positive terminal and negative terminal are connected to the main torch and work-piece respective, a bypass power supply whose positive terminal and negative terminal are connected to the main torch and bypass torch respectively, a fixture which hold the main torch and bypass torch at fixed relative position, and a motion system to carry the fixture and torches to travel at given speed.

2. The method in claim 1, wherein the currents of the main arc between the main wire and work-piece and the bypass arc between the two wires are adjusted by adjusting the main wire and bypass wire respectively.

3. The method in claim 1, wherein the inter-wire angle is appropriately arranged to maintain the simultaneous presence of the main arc and bypass wire.

4. An arc welding method to make fillet welds using the method in claim 1 with an intentional gap.

5. The method in claim 4, wherein the main wire points to the corner of the fillet joint with approximately 60 degrees with the panel.

6. The method in claim 4, wherein an angular beam scale is used to initially position the tip of the main wire.

7. The method in claim 4, where in the bypass wire is initially positioned by setting back it with an appropriate length from the tip of the main wire.

8. A method to start the arcs in the method in claim 4 by gradually increasing the travel speed.

9. An arc welding procedure to make fillet welds on approximately 3/16 inch thick plates in claim 4 with (base metal current, bypass current, travel speed, main arc voltage, bypass arc voltage, inter-wire angle, main wire to panel angle) to be approximately (240 A, 160 A, 45 IPM, 28V, 28V, 45 degree, 60 degree).
